(19) United States
(12) Patent Application Publication
(10) Pub. No.: US 2010/0021103 A1
(43) Pub. Date: Jan. 28, 2010

(54) WAVELENGTH BLOCKER

(75) Inventors: Shinji Mino, Kanagawa-ken (JP); Kenya Suzuki, Kanagawa-ken (JP); Naoki Ooba, Kanagawa-ken (JP)

Correspondence Address: Workman Nydegger;1000 Eagle Gate Tower, 60 East South Temple, Salt Lake City, UT, 84111, US

(73) Assignee: NIPPON TELEGRAPH AND TELEPHONE CORPORATION, Tokyo (JP)

(21) Appl. No.: 12/441,705

(22) PCT Filed: Sep. 21, 2007
(86) PCT No.: PCT/JP2007/068334

§ 371 Date: Mar. 17, 2009

(30) Foreign Application Priority Data
Sep. 21, 2006 (JP) 2006-256355

(51) Int. Cl. G02F 1/01; G02B 6/42

(52) U.S. Cl. 385/1; 385/31

(57) ABSTRACT

An object of the present invention is to provide a wavelength blocker having the function of adjusting or cutting off the light intensity of a wavelength division multiplexed (WDM) optical signal of a given wavelength. The wavelength blocker provided by the present invention has the following features. Specifically, the wavelength blocker has a structure configured to cut off light of any diffraction order other than required diffraction order, contained in an optical signal diffracted by an arrayed waveguide grating that demultiplexes a wavelength, and thus, the wavelength blocker has crosstalk characteristics or an extinction ratio superior to those of a conventional wavelength blocker and thus has optimum packaging design. Further, the wavelength blocker can become smaller in size than the conventional wavelength blocker, and enables achieving polarization independence and cost reduction.

### TECHNICAL FIELD

The present invention relates to a wavelength blocker applicable to an optical communication system.

### BACKGROUND ART

Optical communication is becoming increasingly larger in capacity and is increasing in transmission capacity using wavelength division multiplexing (WDM). Meanwhile, there is a strong demand for an increase in throughput of path switching function at a node. At present, an electric switch is used for the path switching, which takes place after the conversion of an incoming transmitted optical signal into an electric signal. However, the exploitation of the feature of the optical signal being the high-speed broad-band signal allows use of an optical switch for the path switching of the optical signal without conversion, thus reducing an apparatus at the node in size and in power consumption. Such a specific system is required to be implemented for example as an optical add/drop multiplexing system using a ring network, and a wavelength blocker or the like is required as a necessary device.

FIG. 1 is a diagram showing functional blocks of a wavelength blocker. An input optical fiber 101 receives input of incoming light in the form of an optical signal subjected to wavelength division multiplexing (WDM), and a wavelength demultiplexer 102 (e.g., an arrayed waveguide grating (AWG)) demultiplexes the optical signal into each signal having a different wavelength, which then in turn are inputted to a variable optical attenuator (VOA) 103. At this point, a loss in the VOA is adjusted to adjust the intensity of an optical signal of a wavelength, or cut off an optical signal of a wavelength. Then, an output wavelength multiplexer 104 multiplexes the optical signals back into one wavelength division multiplexed optical signal to form outgoing light, which then in turn exits through an output optical fiber 105. Main functions of the wavelength blocker are to adjust the light intensity of an optical signal of a wavelength of the wavelength division multiplexed optical signal, for example to make the light intensity uniform, and for example to cut off (or block) an optical signal of an unwanted wavelength that has already dropped out.

The wavelength blocker has heretofore been implemented by a spatial optical system consisting of a spatial diffraction grating and a spatial modulation element, using the spatial diffraction grating as a wavelength multiplexer/demultiplexer. However, it is difficult to carry out the optimum packaging design for the high-precision spatial placement of the spatial diffraction grating and the spatial modulation element, also in consideration of temperature changes.

On the other hand, one leading means for implementing the wavelength blocker is to use a planar lightwave circuit (PLC) as the wavelength multiplexer/demultiplexer and use a liquid crystal element as the spatial modulation element. For example, Patent Document 1 discloses the wavelength multiplexer/demultiplexer using the PLC, and the spatial modulation element using the liquid crystal element.

However, the wavelength multiplexer/demultiplexer and the spatial modulation element disclosed in Patent Document 1 are intended for signal processing, and thus, Patent Document 1 does not give a sufficient description as to a packaging structure for the wavelength multiplexer/demultiplexer and the spatial modulation element, the design of a PLC component, and properties, required for the wavelength blocker. Therefore, the disclosure of Patent Document 1 is incapable of providing an optimum wavelength blocker and thereby achieving cost reduction.

Further, the use of the AWG as the PLC component for the wavelength multiplexer/demultiplexer leads to the problem of causing deterioration and consequently degradation of important properties such as crosstalk (i.e., the leak of an optical signal from a different channel) or an extinction ratio (i.e., 10 log 10 (the light intensity in a case where an optical signal is allowed to transmit/the light intensity in a case where an optical signal is prohibited from transmitting)), because of not cutting off diffracted beams of light of any diffraction order other than the diffraction order m of desired diffracted beam of light, such as the (m+1)th or (m−1)th order diffracted beam of light, where m represents any given integer.

Further, there exists the problem that polarization independence of the wavelength blocker, although required for use as an optical communication device, is still not achieved.

Patent Document 1: Japanese Patent No. 3520072

### DISCLOSURE OF THE INVENTION

In order to solve the foregoing problems, a wavelength blocker of the present invention is characterized by providing a specific structure, the design of a PLC and optical components, and a packaging structure, required to achieve the wavelength blocker having the function of adjusting the light intensity of a wavelength division multiplexed (WDM) optical signal of a given wavelength, or cut off a wavelength division multiplexed (WDM) optical signal of a given wavelength.

Further, the wavelength blocker of the present invention is characterized by the main feature that, for diffracted beams of light of any diffraction orders other than a desired diffraction order m (where m represents any given integer), a light shield structure is provided on a glass substrate of a liquid crystal element in the right and left or top and bottom margins of the substrate, exclusive of a region which the mth order diffracted beam of light enters (that is, the central area of the substrate and its vicinity) thereby to eliminate stray light that can possibly cause deterioration in crosstalk or an extinction ratio. Here, a package with a window, configured to fix the liquid crystal element, may be used as the light shield structure. Alternatively, the light shield structure maybe disposed outside the package.

Further, the wavelength blocker of the present invention is characterized by the main feature that, in order to enable polarization independence required for actual implementation of an optical communication device, a combination of an optical circulator and a polarization beam splitter is used to split a polarized wave into two light beams, which then enter two AWGs respectively and each further enter the liquid crystal element and bounce back, thereby achieving polarization independence, using a small-sized structure.

The present invention provides the wavelength blocker having the function of adjusting the light intensity of the wavelength division multiplexed (WDM) optical signal of a given wavelength or cutting off a wavelength division multiplexed (WDM) optical signal of a given wavelength.

### BRIEF DESCRIPTION OF THE DRAWINGS

FIG. 1 is a diagram showing the function of a wavelength blocker;

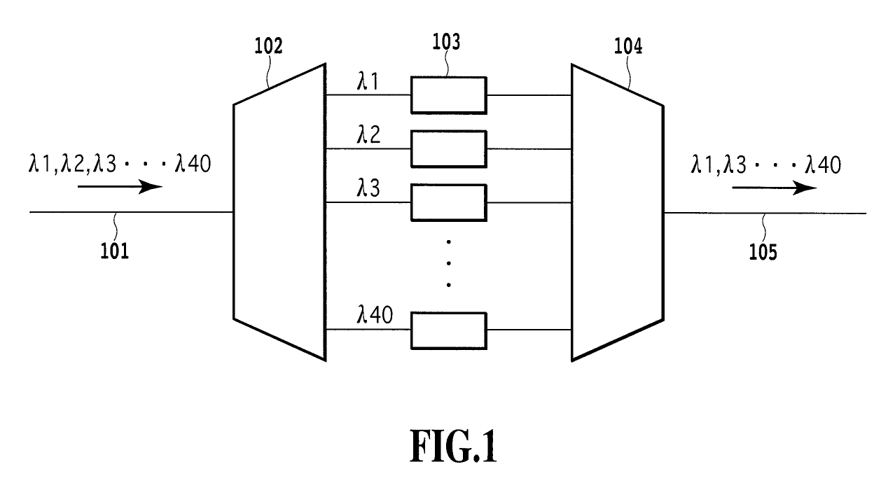

FIG. 2 is a plan view for explaining a first embodiment;

FIG. 3 is a view showing details of an arrayed waveguide grating;

FIG. 4 is a chart showing a distribution of intensity of a beam of light with a center wavelength in a focal plane S3;

FIG. 5 is a front view of a liquid crystal element;

FIG. 6 is a side view of the liquid crystal element;

FIG. 7 is a view showing a liquid crystal element provided with a light shield pattern;

FIG. 8 is a view showing a liquid crystal element provided with a light shield pattern;

FIG. 9 is a view showing an example of a liquid crystal element with a light shield plate added thereto;

FIG. 10 is a side view of the liquid crystal element provided with polarizers in front thereof and therebehind, respectively;

FIG. 11 is a side view for explaining the first embodiment;

FIG. 12 is a plan view for explaining a second embodiment;

FIG. 13 is a side view for explaining an example of the assembly structure of the second embodiment;

FIG. 14 is a plan view for explaining the example of the assembly structure of the second embodiment;

FIG. 15 is a side view for explaining the example of the assembly structure of the second embodiment;

FIG. 16 is a side view for explaining a third embodiment;

FIG. 17 is a perspective view showing a structure for connection of an optical fiber array to a PLC;

FIG. 18 is a plan view for explaining a fourth embodiment;

FIG. 19 is a side view for explaining the fourth embodiment;

FIG. 20 is a plan view for explaining a fifth embodiment;

FIG. 21 is a plan view for explaining a sixth embodiment;

FIG. 22 is a plan view for explaining a seventh embodiment;

FIG. 23 is a side view for explaining an eighth embodiment;

FIG. 24 is a plan view for explaining a ninth embodiment;

FIG. 25 is a plan view for explaining a tenth embodiment;

FIG. 26 is a plan view for explaining an example of the assembly structure of the tenth embodiment;

FIG. 27 is a side view for explaining the example of the assembly structure of the tenth embodiment;

FIG. 28 is a plan view for explaining an eleventh embodiment;

FIG. 29 is a side view for explaining the eleventh embodiment;

FIG. 30 is a side view for explaining a twelfth embodiment;

FIG. 31 is a side view for explaining a thirteenth embodiment;

FIG. 32 is a plan view for explaining a fourteenth embodiment;

FIG. 33 is a side view for explaining a fifteenth embodiment; and

FIG. 34 is a side view for explaining a sixteenth embodiment.

### BEST MODE FOR CARRYING OUT THE INVENTION

Embodiments of the present invention will be described in detail below with reference to the drawings.

### First Embodiment

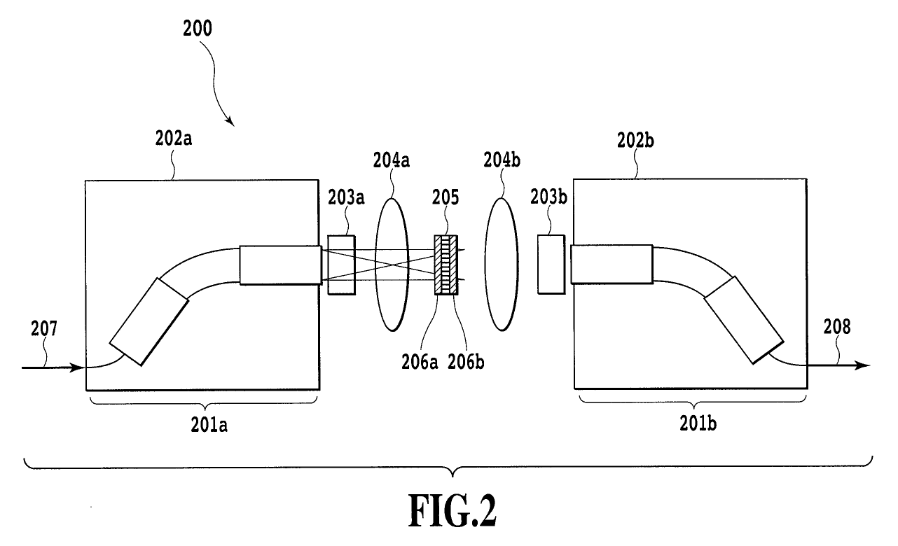

FIG. 2 is a plan view for explaining a wavelength blocker 200 according to a first embodiment of the present invention. As shown in FIG. 2, the wavelength blocker 200 according to the first embodiment includes a PLC 202a including an AWG 201a connected at its input to an optical fiber 207, and a cylindrical lens 203a, a collimating lens 204a, and a spatial modulation element 1108 constructed of a liquid crystal element 205 sandwiched in between polarizers 206a and 206b are arranged in this order on the optical axis of the AWG 201a in the output thereof. A collimating lens 204b and a cylindrical lens 203b are arranged on the optical axis of the spatial modulation element 1108 in the output thereof, and are optically coupled to a PLC 202b including an AWG 201b connected to an output optical fiber 208.

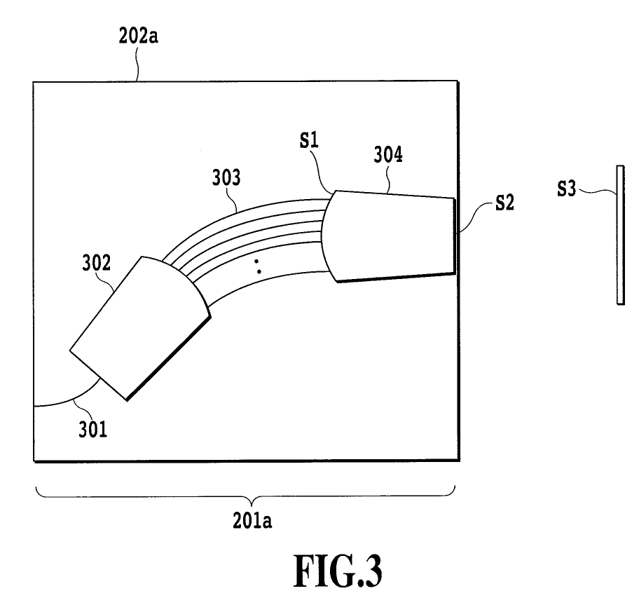

FIG. 3 shows details of the AWG 201a. As shown in FIG. 3, the AWG 201a is formed of a first slab waveguide 302 connected to an input optical waveguide 301, a second slab waveguide 304 having an exit plane in the PLC 202a in its section S2, and an arrayed waveguide 303 by which the first and second slab waveguides 302 and 304 are connected together.

An input signal inputted through the input optical waveguide 301 passes through the first slab waveguide 302, then through the arrayed waveguide 303, and through an interface S2 between the arrayed waveguide 303 and the second slab waveguide 304, starts diffraction in the second slab waveguide 304, exits into the space through the space-contacting section S2 of the second slab waveguide 304, and undergoes demultiplexing to form signals of wavelengths in a focal plane S3 in which the input signal is demultiplexed into signals each having a different wavelength. As employed here, the focal plane S3 may be in a straight or curved line. Also, in the first embodiment, the PLC is not limited to that including the second slab waveguide 304 but may be adopted as being cut before the end of the arrayed waveguide 303. Light emitting from the end of the arrayed waveguide 303 is diffracted in the space, even in the absence of the second slab waveguide 304 as mentioned above.

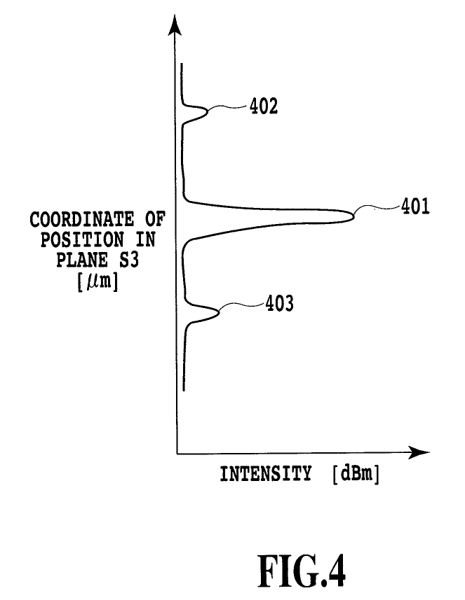

FIG. 4 shows how the intensity of light with a center wavelength of the AWG 201a shown in FIG. 3, for example, a wavelength of 1545 nm, is distributed in the focal plane S3 when the light is diffracted. In FIG. 4, a peak width is shown as being somewhat greater than the actual peak width. If the mth order diffracted beam of light lies in the center of the focal plane S3 as mentioned above, the (m−1) th and (m+1) th order diffracted beams of light each appear in a place corresponding to the free spectral range (FSR) of the AWG 201a. Desirably, the (m−1) th and (m+1)th order diffracted beams of light are eliminated, because each of these diffracted beams of light propagates through the space to form stray light, undergoes reflection or does the like inside a package, and in turn, gets mixed in an optical signal within the output AWG 201b to form a crosstalk component that can possibly affect the optical signal. However, an envelope that links the intensity peaks of the (m−1)th, mth and (m+1)th order diffracted beams of light is generally in a gentle curve that approximates to Gaussian distribution. Assuming here that wavelength signals contained in the mth order diffracted beam of light are WDM signals of 45 wavelengths of 1527 nm to 1563 nm, at 100-GHz spacing, lying within the C band, and that these signals are adjusted to become uniformly low in loss. Then, a sharp reduction of the envelope to zero is difficult, and thus, the peak of the adjacent (m−1)th and (m+1)th order diffracted beams of light remain as shown in FIG. 4. The diffracted beams of light of the mth order with a wavelength of 1545 nm are here given as an example. This diffracted beams of light, as they are, can possibly be radiated into the air, undergo reflection or do the like inside a module to form stray light, get mixed in an optical signal component, and hence cause deterioration in crosstalk characteristics. It is therefore desirable that the (m−1)th and (m+1)th order diffracted beams of light be cut off and thereby eliminated. The first embodiment enables cutting off and thereby eliminating the above-mentioned (m−1)th and (m+1)th order diffracted beams of light, as later described.

Also, in order to prevent light from diverging in a vertical direction perpendicular to the direction of travel of the light, the cylindrical lenses 203a and 203bbring the light into convergence so as to avoid vertical divergence. Further, the collimating lenses 204a and 204b bring the light into convergence both in the vertical direction perpendicular to the direction of travel of the light and in a horizontal direction thereby to control the focal plane S3.

In the first embodiment, the liquid crystal element is used as the spatial modulation element. The liquid crystal element can control the angle of rotation for polarization by applied voltage, and thus functions as a variable optical attenuator in combination with the polarizer.

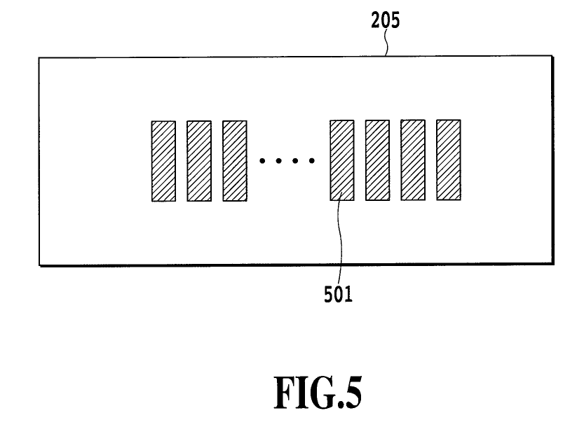

FIG. 5 is a front view of the liquid crystal element 205. The liquid crystal element 205 has transparent ITO (indium tin oxide) electrodes 501 formed in patterns therein. In FIG. 5, the pitch of the patterns of the ITO electrodes 501 is set equal to 50 μm, and the gap therebetween is set equal to 5 μm. Design is such that optical signals corresponding to wavelength signals enter pads of the ITO electrodes 501, respectively, assuming that the optical signals entering the wavelength blocker 200 are for example the signals of 45 channels, spaced at frequency intervals of 100 GHz, lying within a 1.55-μm wave band. Then, a voltage can be applied to the pads to control transmission loss of signals each having a different wavelength, and thus independently control the light intensities of signals each having a different wavelength. Further, the loss may be increased to 40 dB to cut off (or block) a given wavelength. In FIG. 5, the ITO electrodes 501 spread across the liquid crystal element 205 to form the pads with 250-μm pitches. Then, the pads are each connected to a flexible printed circuit board (FPC) cable so that the pads are individually subjected to an externally applied voltage.

Although a twisted nematic type of liquid crystal element is here given as an example of the spatial modulation element, it is to be understood that the spatial modulation element is not limited particularly to the twisted nematic type liquid crystal element, and other types may be used, provided that they have the same function as the above type. Further, it is to be understood that the spatial modulation element is not limited to the liquid crystal element, and anything may be used, provided that it can function as an optical intensity attenuator.

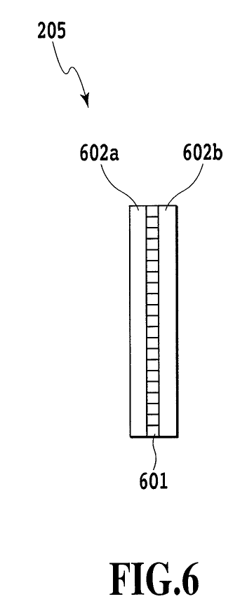

FIG. 6 shows a side view of the liquid crystal element 205. As shown in FIG. 6, the liquid crystal element 205 has a structure in which a liquid crystal 601 is covered with glass substrates 602a and 602b. The glass substrates 602a and 602b each have a thickness of 1 mm or less, and the liquid crystal element 205 in itself has a thickness on the order of 10 μm.

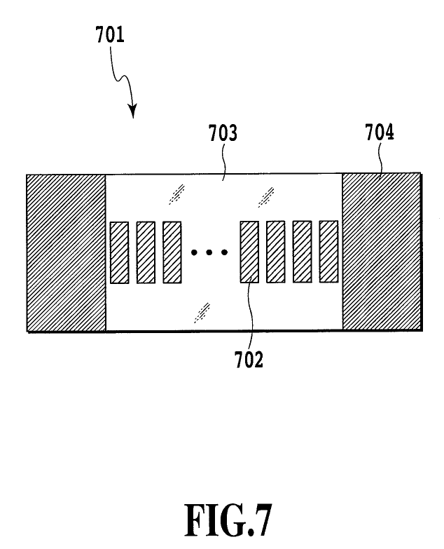

FIG. 7 shows a liquid crystal element 701 contrived to cut off the (m−1)th and (m+1)th order diffracted beams of light to form the stray light as previously mentioned. The liquid crystal element 701 has ITO electrodes 702 therein, covered with a glass substrate 703. The (m−1)th and (m+1)th order stray beams of light are cut off by a light shield pattern 704.

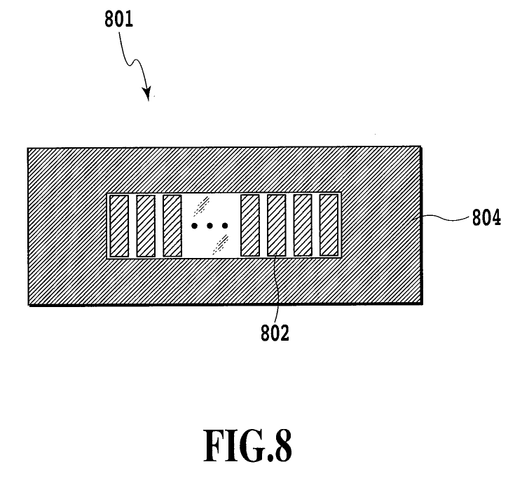

FIG. 8 shows another liquid crystal element 801 contrived to cut off the (m−1)th and (m+1)th order stray beams of light. In the liquid crystal element 801, a light shield pattern 804 is disposed so as to enclose ITO electrodes 802 from the tops and bottoms thereof in order to prevent the stray light from being reflected by the inner surface of the liquid crystal element and being scattered in various directions.

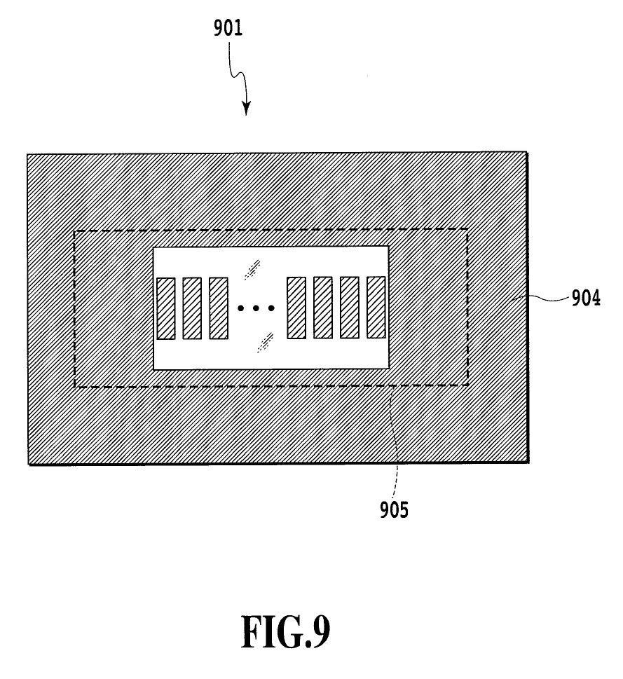

FIG. 9 shows still another liquid crystal element 901 contrived to cut off the (m−1)th and (m+1)th order stray beams of light. The liquid crystal element 901 has a light shield plate 905 configured to cut off the stray light also in surrounding space, in addition to a light shield pattern 904, and thus has the extended cutoff range of the stray light.

Although FIGS. 7 to 9 show the typical liquid crystal elements 701, 801 and 901, respectively, for cutting off diffracted beams of light of any diffraction order other than the diffraction order m, it is to be understood that the liquid crystal element for cutoff is not limited to the liquid crystal elements 701, 801 and 901, and any liquid crystal element may be used, provided that the liquid crystal element has the same advantageous effect.

Although description has been given above with regard to the liquid crystal element for cutting off stray light of any diffraction order other than the diffraction order m, for use in the wavelength blocker 200 configured of the PLC, it is to be understood that the PLC may be replaced by a spatial diffraction grating, or a diffraction grating using a grating.

The typical values of dimensions of a PLC component actually optically designed and fabricated are as follows.

In the absence of the second slab waveguide of the AWG, the distance between the end face of the PLC and the liquid crystal element is set equal to 50 mm.

In the presence of the second slab waveguide of the AWG, the length of the second slab waveguide of the AWG is set equal to 25 mm, and the distance between the end face of the PLC and the liquid crystal element is set equal to 3 mm.

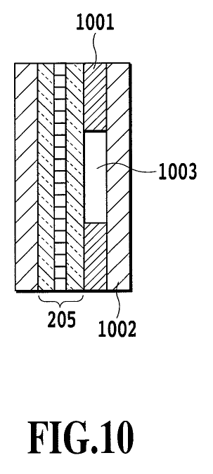

Incidentally, the polarizer is used for example in the form of a thin sheet of about 0.05 mm to 0.3 mm thick. Then, one example of structure is that the polarizer is bonded directly to the liquid crystal element by an ultraviolet-curing adhesive. However, the entry of high-power light causes the rear polarizer to produce heat, and thus, a frame 1001 may be used for bonding in such a manner as to form an air gap 1003 between the liquid crystal element 205 and a polarizer 1002, as shown in FIG. 10, for example. The provision of the air gap as mentioned above reduces the likelihood that the heat produced by the polarizer 1002 will be transferred to the liquid crystal element 205, thus enabling excellent packaging design.

Also, an anti-reflection coating is applied to each optical component in a portion thereof corresponding to an optical path in order to prevent light from being reflected back.

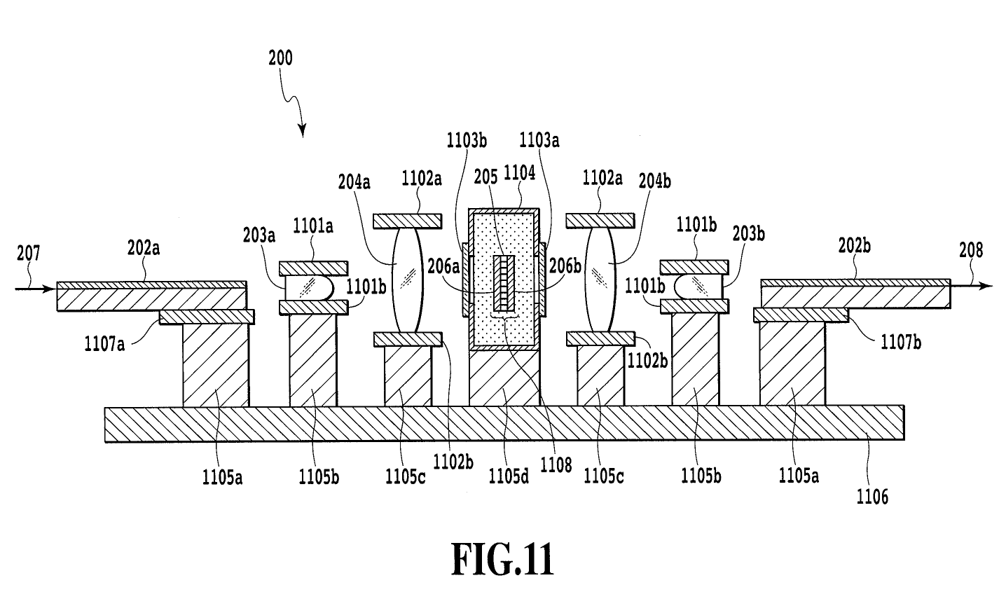

FIG. 11 shows a side view of the wavelength blocker 200 according to the first embodiment. Here, the components are fixed in alignment, in order, with respect to an optical aligning substrate 1106. The PLCs 202a and 202b, the cylindrical lenses 203a and 203b, and the collimating lenses 204a and 204b are fixed to optical aligning members 1101a, 1101b, 1102a, 1102b, 1107a and 1107b by being fixed to a metal plate, for example a stainless steel plate, or a stainless steel frame, either by a low melting glass, by caulking, by soldering, or by doing the like. Here, the members 1101a and 1101b may form an integral member. The side face also may include a member, although the side face is omitted so that the lens can be seen. Also, the spatial modulation element 1108 is formed of the liquid crystal element 205 and the polarizers 206a and 206b between which the liquid crystal element 205 is interposed, and is fixed in a package 1104 provided with glass windows 1103a and 1103b in both sides thereof. Then, the PLCs 202a and 202b, the cylindrical lens 203a, the collimating lens 204a, and the package 1104 are fixed on metallic pedestals 1105a, 1105b, 1105c and 1105d, respectively. Here, the pedestals 1105a, 1105b, 1105c and 1105d are slidable on the optical aligning substrate 1106 to adjust their positions in a plane. Also provided are joint portions such that the heights and orientations of the pedestals 1105a, 1105b, 1105c and 1105d are somewhat adjustable.

YAG laser welding, for example, can be used to fix the package 1104 to the pedestal 1105d. The YAG welding has heretofore been used to connectedly fix a lens or an optical fiber to a package of a laser module. However, since irradiation with light from the YAG laser causes a misalignment, it is required that the shape of the member or a method for YAG laser irradiation be contrived to prevent the misalignment, or alternatively, it is necessary to compensate for the misalignment. However, this is solved in the following manner, and the YAG welding has the merit that, once the member is fixed by the YAG welding, there is little misalignment due to a change with time, and high reliability is ensured.

Specifically, the approach of observing output field for the optical components, the PLCs, the lenses or the like with respect to the optical aligning substrate, using a cameral or the like is used for active optical alignment. Then, the components are fixed by the YAG laser. This operation can be repeated to fix the components in sequence with stability.

Incidentally, in the first embodiment, fixing by the YAG welding is used; however, it is to be understood that solder, cream solder, a resin adhesive or the like may be used for connected fixing. In the first embodiment, since the misalignment tolerance of loss or other characteristics is great and the bonding contact area is large, adhesive fixing may be adopted after allowing for characteristic and reliability conditions.

In the first embodiment, the package containing the liquid crystal element is accurately connected to a stainless steel member for the YAG welding. The package for hermetic sealing may be used. The package can reduce factors that can possibly affect the reliability of the liquid crystal element in a high-humidity environment. Also, the light shield pattern 904 and the light shield plate 905 shown in FIG. 9 may be placed on the liquid crystal element 205 within the package 1104.

Also, in the wavelength blocker 200, the extinction ratio of the liquid crystal element 205 may be set for example to a high extinction ratio of 40 dB or more in order to block a given wavelength. Two liquid crystal elements 205 may be used in combination in order to provide a sufficient margin for the extinction ratio of the liquid crystal element 205. For example, even if the liquid crystal element 205 has only an extinction ratio of 30 dB, an in-series combination of two liquid crystal elements 205 can achieve an extinction ratio of 60 dB.

### Second Embodiment

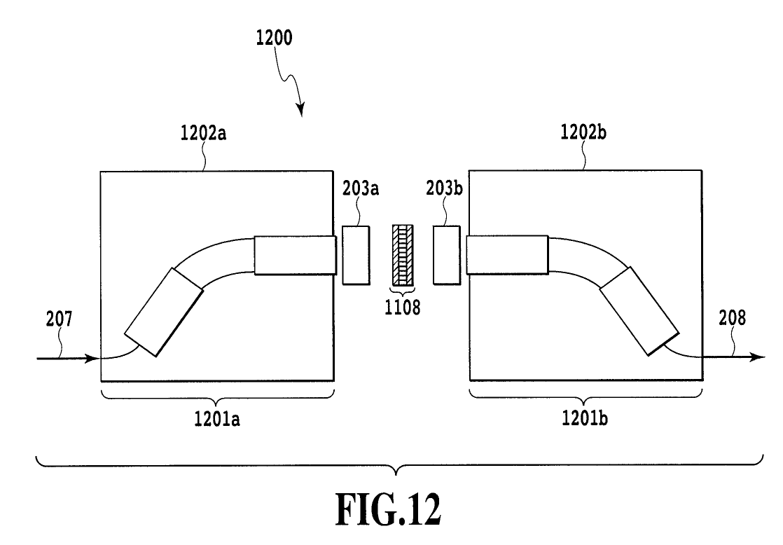

FIG. 12 shows a plan view of a wavelength blocker 1200 according to a second embodiment. The wavelength blocker 1200 is identical to the wavelength blocker 200 according to the first embodiment except for respects mentioned below. The wavelength blocker 1200 according to the second embodiment includes PLCs 1202a and 1202b including AWGs 1201a and 1201b made of silica glass, the cylindrical lenses 203a and 203b, and the spatial modulation element 1108 formed of the liquid crystal element 205 and the polarizers 206a and 206b. The AWG 1201a is designed to suppress horizontal divergence relative to the direction of travel of a beam, as compared to the AWG 201a according to the first embodiment shown in FIG. 3. This contrivance enables the second embodiment to omit the collimating lenses 204a and 204b used in the first embodiment. As a result, the second embodiment enables reductions in a component count and packaging cost.

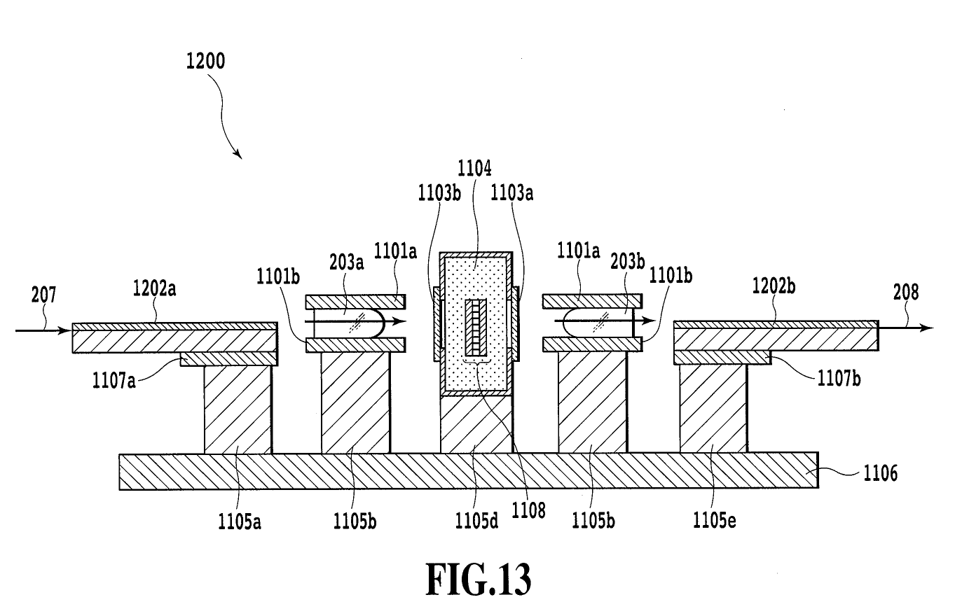

FIG. 13 is a side view of the wavelength blocker 1200 according to the second embodiment. In the second embodiment, the PLCs 1202a and 1202b and the cylindrical lenses 203a and 203b are fixed to the optical aligning members 1101a, 1101b, 1107a and 1107b by being fixed to a metal plate, for example a stainless steel plate, or a stainless steel frame, either by a low melting glass, by caulking, by soldering, or by doing the like. Details of this fixing are the same as the first embodiment.

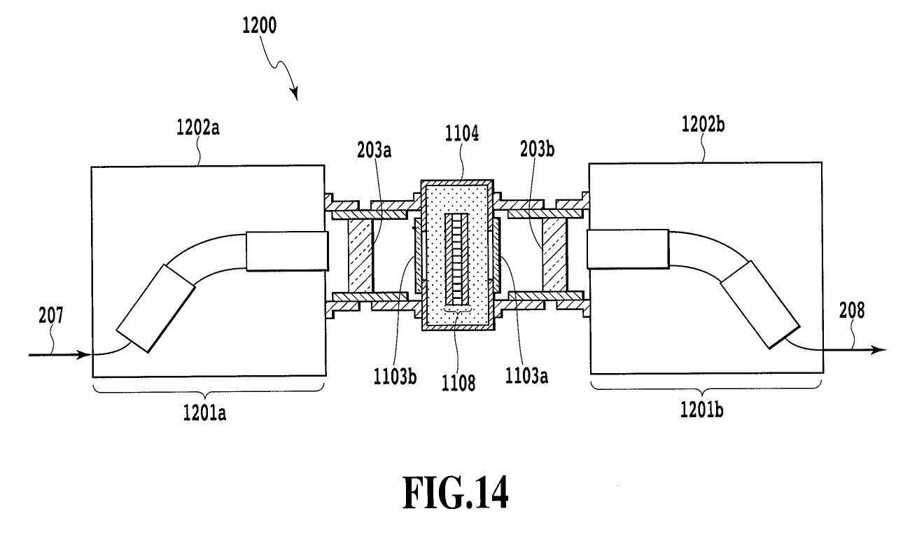

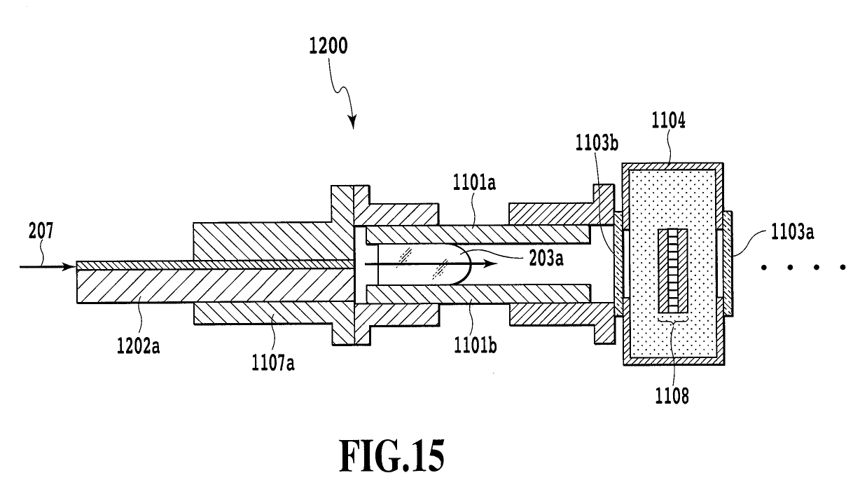

FIG. 14 is a plan view showing an example of packaging of the wavelength blocker 1200 according to the second embodiment. Further, FIG. 15 is a side view showing the example of packaging of the wavelength blocker 1200 according to the second embodiment. Some members are omitted from FIGS. 14 and 15 so that the contents can be seen. The optical aligning members 1101a, 1101b, 1107a and 1107b are designed to have the same function as the stainless steel member for use in connected fixing by the YAG laser welding for a general connection between an LD module and an optical fiber. Specifically, the members are used in such a configuration that they can be fine-tuned in the directions of the X, Y and Z axes in accordance with predetermined given coordinates, be aligned so as to minimize optical coupling loss and then be connectedly fixed by the YAG laser.

Also, it is desirable that the PLCs 1202a and 1202b and the spatial modulation element 1108 be kept constant for example at 25° C. by a cooling device such as a Peltier device, depending on required characteristics, and the wavelength blocker 1200 according to the second embodiment does not have the collimating lenses, thus brings the PLC correspondingly closer to the spatial modulation element, and thus makes it easier to achieve packaging design such that both the PLC and the spatial modulation element are kept at 25° C., as compared to the first embodiment.

### Third Embodiment

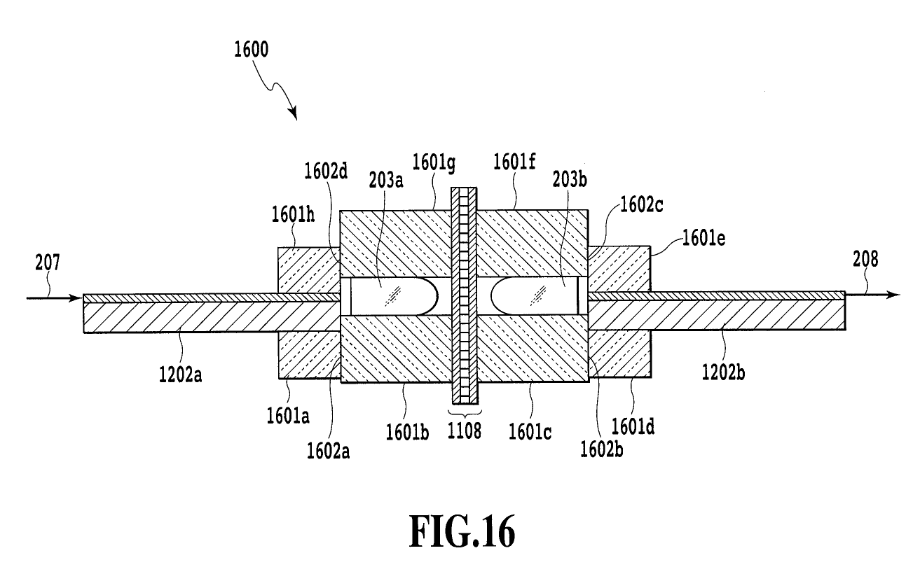

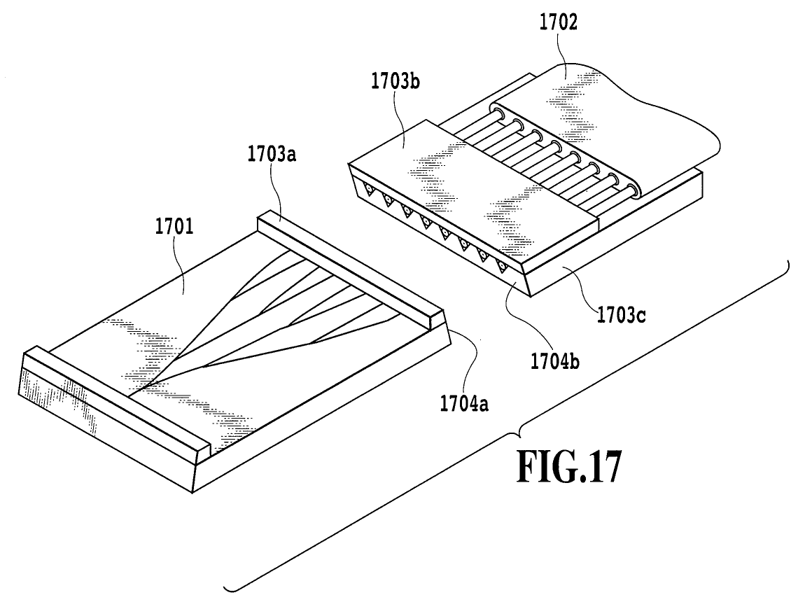

FIG. 16 shows a side view of a wavelength blocker 1600 according to a third embodiment. The wavelength blocker 1600 can use a glass block 1601 to increase the bonding area of a bonding surface 1602 of the component and thus is more suitable for adhesive fixing, as compared to the wavelength blocker 1200 according to the second embodiment. FIG. 17 shows an instance where a PLC 1701 and an optical fiber array 1702 are connectedly fixed by using a glass block 1703 and applying an adhesive to bonding surfaces 1704a and 1704b for bonding, as an example of use of the glass block. Such a connection has already become commercial and also has sufficiently high reliability. The wavelength blocker 1600 uses this field-proven adhesive fixing. In the wavelength blocker 1600, glass blocks 1601a and 1601h are adhesively bonded on the upper and under sides of the PLC 1202a, and then, the end face of the PLC 1202a is polished. Also for the cylindrical lens 203a, glass blocks 1601b and 1601g are likewise adhesively bonded on the upper and under sides of the cylindrical lens 203a. Alternatively, a material for the cylindrical lens 203a is the same as a material for the glass blocks 1601b and 1601g, and thus, the cylindrical lens 203a and the glass blocks 1601b and 1601g may be integrally molded by a mold and thereby fabricated. The same holds for the cylindrical lens 203b. Alternatively, a cylindrical lens having a spherical end face may be used. This cylindrical lens has the shape of a rectangular parallelepiped, and thus can be easily connectedly fixed by using the adhesive.

The polarizers 206a and 206b and the liquid crystal element 205 included in the spatial modulation element 1108 are also each made of a glass substrate. Thus, they may be adhesively fixed to each other in sequence to fabricate the wavelength blocker 1600. Both a material for the polarizers 206a and 206b and a material for the liquid crystal element 205 are the glass substrate, and thus, there is a small difference in coefficient of thermal expansion therebetween, so that the reliability of adhesive fixing can be as high as that of PLC-optical fiber connected fixing. A procedure for the adhesive fixing is as follows. First, the polarizers and the liquid crystal element are placed on a precision stage, and are fixed in good coupled relation by aligning them with each other while actually passing light through them and monitoring coupling loss. Then, an ultraviolet-curing adhesive is injected into joints between the polarizers and the liquid crystal element, and they are fixed by being irradiated with ultraviolet light. Alternatively, only the periphery of an optical axis may be adhesively fixed so that the adhesive does not extend to the optical axis. This operation is repeated in sequence to fabricate the wavelength blocker 1600. Such fabrication using the adhesive fixing using the adhesive eliminates the need for the expensive YAG laser. Also, a contact limits the angles of the polarizers and the liquid crystal element, and thus, the aligning axis of the precision stage for use in packaging is shorter. This enables using a low-priced packaging apparatus, and also enables a reduction in packaging time and hence a reduction in packaging cost.

Incidentally, further, the wavelength blocker 1600 fabricated as mentioned above may be sealed in a package for hermetic sealing.

### Fourth Embodiment

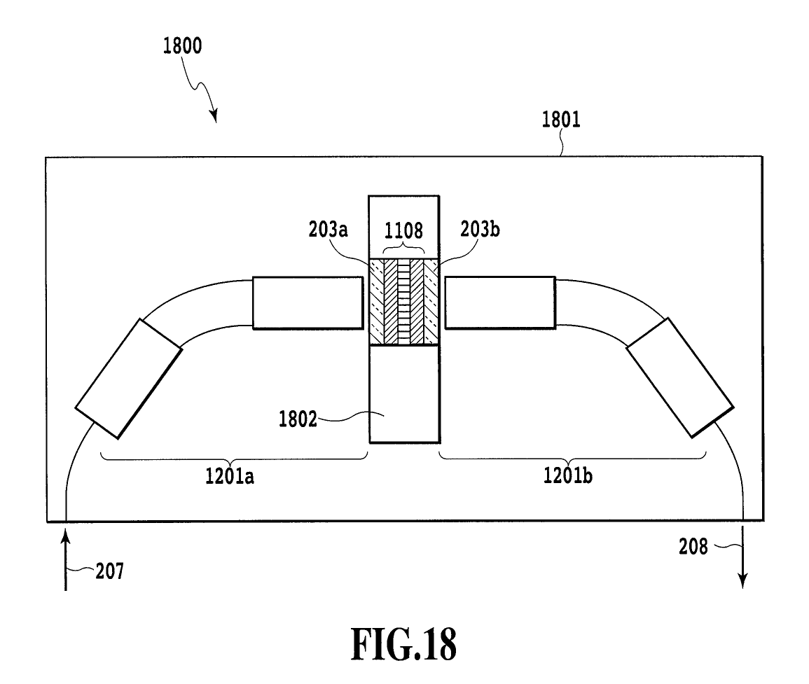

FIG. 18 shows a plan view of a wavelength blocker 1800 according to a fourth embodiment, in which the PLCs 1202a and 1202b on both sides of the spatial modulation element 1108 of the wavelength blocker 1600 according to the third embodiment are integral with each other.

In the wavelength blocker 1800, a hole 1802 in the shape of a rectangular parallelepiped having dimensions of 15 mm long and 3 mm wide, as shown in FIG. 18, is formed by a dicing saw in a substrate 1801 on which the two AWGs 1201a and 1201b are fabricated, and the spatial modulation element 1108 and the cylindrical lenses 203a and 203b are inserted in the hole 1802.

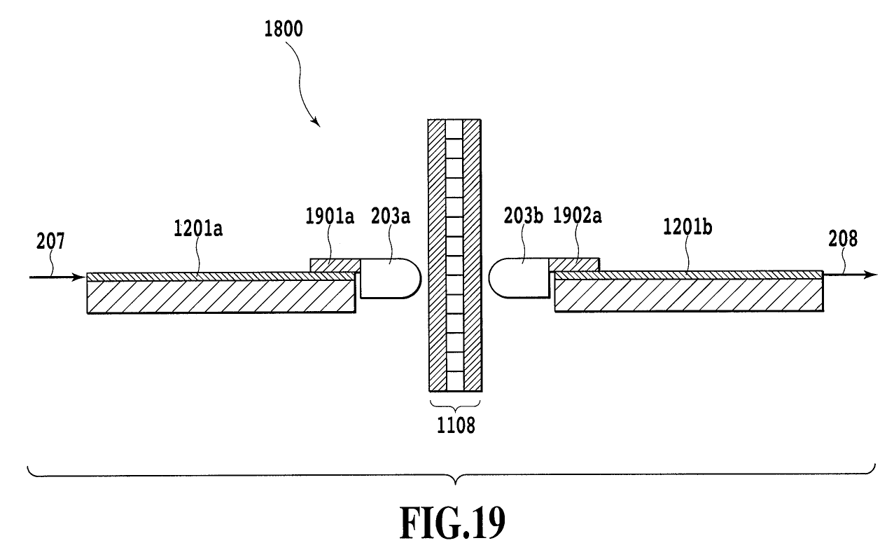

FIG. 19 shows a side view of the wavelength blocker 1800. As shown in FIG. 19, the cylindrical lenses 203a and 203b are provided with guide plates 1901a and 1901b, respectively, so that the lenses can be positioned with respect to the top surfaces of the AWGs 1201a and 1201b that form the PLC components. The guide plates 1901a and 1901b may be integrally fabricated with the cylindrical lenses 203a and 203b, when the cylindrical lenses 203a and 203bare fabricated by casting using a mold. Alternatively, the guide plates 1901a and 1901b and the cylindrical lenses 203a and 203b fabricated at separate steps may be bonded together after fabrication.

As described above, the relative positions of the two AWGs that form the PLC components are determined by the accuracy of a mask pattern over the one hole 1802, which in turn achieves easier alignment and also easier packaging.

The packaging of the wavelength blocker 1800 is done in the same manner as the third embodiment. Specifically, the spatial modulation element 1108 formed of the liquid crystal element 205 and the polarizers 206a and 206b adhesively integrally formed in advance, and the cylindrical lenses 203a and 203b are independently fixed on the precision stage, the spatial modulation element 1108 is inserted into the above-mentioned hole 1802, and the spatial modulation element 1108 and the polarizers 206a and 206b are aligned with each other. At this time, active alignment using monitoring light may be used to monitor characteristics and thereby enables more reliable packaging.

The insertion of the spatial modulation element 1108 in the hole 1802 as mentioned above ensures, in advance, the alignment between the PLC components (i.e., the AWGs 1201a and 1201b) and the spatial modulation element 1108 by the mask pattern accuracy. This enables a reduction in the count of components requiring alignment, and thus reductions in the packaging time and packaging cost.

### Fifth Embodiment

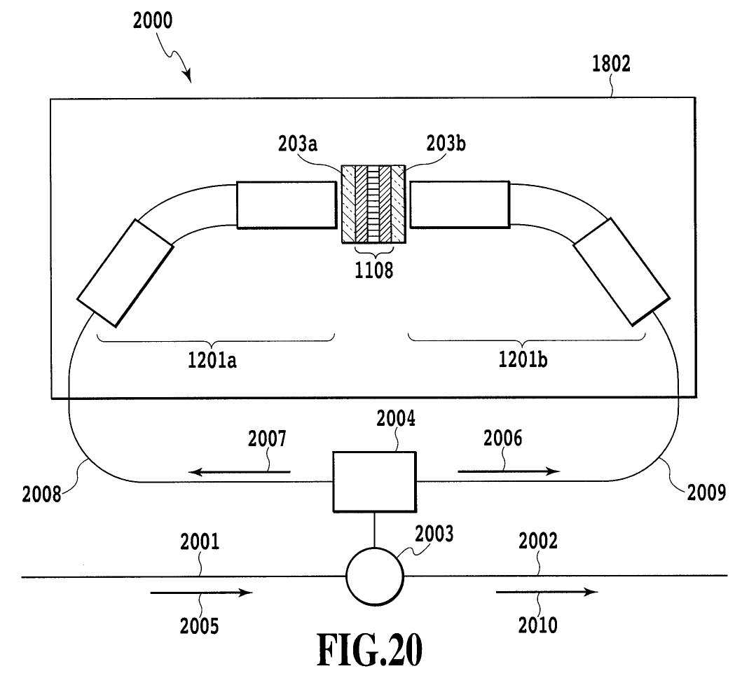

FIG. 20 shows a plan view of a wavelength blocker 2000 according to a fifth embodiment. In order for an actual optical communication system to use the wavelength blocker 1800, it is required that the wavelength blocker 1800 be capable of being used with optical properties remaining unchanged, that is, without depending on polarization, even if incoming light changes in its polarization state. However, the spatial modulation element 1108 in itself including the liquid crystal element 205 is polarization-dependent, and thus, the polarization independence of the wavelength blocker 1800 is required. The wavelength blocker 2000 implements polarization-independent operation, as described below. An input optical fiber 2001 and an output optical fiber 2002 are connected to a circulator 2003, which is connected to a polarization beam splitter (PBS) 2004. Incoming light 2005 passes through the input optical fiber 2001. The PBS 2004 splits the incoming light 2005 into light beams by polarization, and, for example, the light (or a signal a (indicated by 2006)) travels in the direction of polarization perpendicular to the sheet in the right-hand part of FIG. 20, while the light (or a signal b (indicated by 2007)) travels in the direction of polarization parallel to the sheet in the left-hand part thereof. Here, the PBS 2004 is linked to the AWGs 1201a and 1201b by polarization holding optical fibers 2008 and 2009, respectively, and only the principal axis of the polarization holding optical fiber 2008 on the left side is rotated 90 degrees between the PBS 2004 and the AWG 1201a, so that the light parallel to the sheet travels through the AWG 1201a. As a result, only a one-way polarized signal passes through the liquid crystal element 205 of the spatial modulation element 1108 having polarization dependence. In this manner, the fifth embodiment enables using the spatial modulation element 1108 having the polarization dependence, without depending on polarization.

Incidentally, description has been given taking an instance where the principal axis of the polarization holding optical fiber 2008 is rotated 90 degrees to rotate the direction of polarization; however, it is to be understood that other means such as a half-wave plate may be used as a means for rotating the direction of polarization.

### Sixth Embodiment

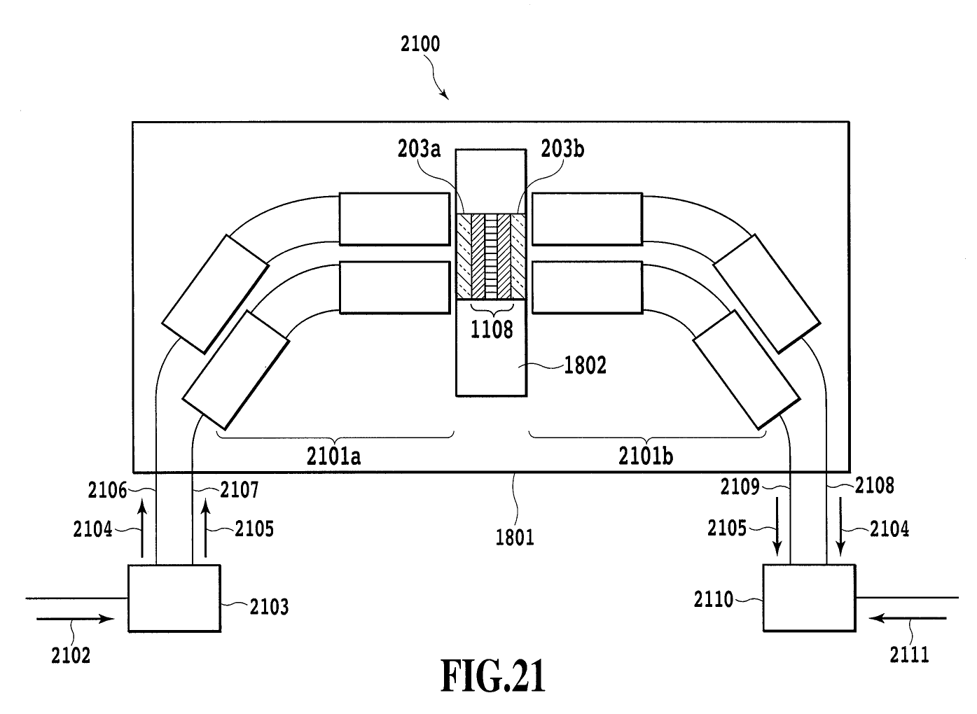

FIG. 21 shows a plan view of a wavelength blocker 2100 according to a sixth embodiment. The wavelength blocker 2100 enables using the spatial modulation element 1108 having the polarization dependence, without depending on polarization, as in the case of the wavelength blocker 2000. As shown in FIG. 21, the wavelength blocker 2100 uses AWG groups 2101a and 2101b each consisting of two AWGs, in place of the AWGs 1201a and 1201b of the wavelength blocker 2000, and an input optical signal 2102 is split by a PBS 2103 into an optical signal a (2104) and an optical signal b (2105) according to the direction of polarization. Here, the PBS 2103 is linked to the AWG group 2101a by polarization holding optical fibers 2106 and 2107, and, as in the case of the fifth embodiment, both the directions of polarization of light beams entering the two AWGs of the optical circuit 2101a are made parallel to the sheet. Light waves polarized and split by the PBS 2103 enter the AWG group 2101a, while holding their polarization state. As a result, both the directions of the polarized waves entering the AWG group 2101a are limited to being parallel to the AWG group 2101a. Consequently, only the polarized waves parallel to the substrate 1801 are inputted to the spatial modulation element 1108. Then, the polarized waves pass through the spatial modulation element 1108 and propagate through the AWG group 2101b, and thereafter, the polarized waves propagate through output polarization holding optical fibers 2108 and 2109 and are multiplexed by a PBS 2110 into an output optical signal 2111 on the right, which is outputted. As mentioned above, the wavelength blocker 2100 enables using the liquid crystal element having the polarization dependence, without depending on polarization.

### Seventh Embodiment

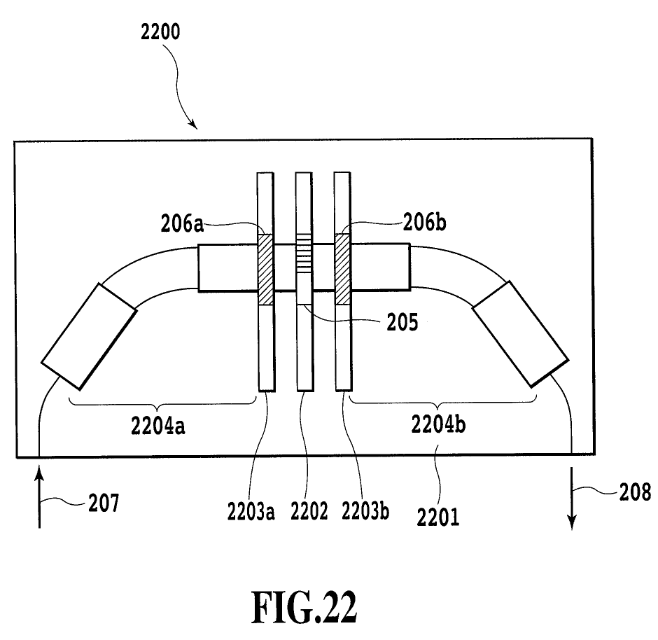

FIG. 22 shows a plan view of a wavelength blocker 2200 according to a seventh embodiment. As shown in FIG. 22, in the wavelength blocker 2200, slots 2202, 2203a and 2203b are formed in a substrate 2201 by dicing, and the thinned liquid crystal element 205 is inserted in the slot 2202. Such a structure has the advantageous effect of easier packaging as compared to FIG. 18, since the liquid crystal element is fixed only by being inserted into the slot.

As shown in FIG. 22, the wavelength blocker 2200 includes AWGs 2204a and 2204b on both sides of the liquid crystal element 205, the slot 2202 of 200 μm wide is formed by a dicing saw in a place where the liquid crystal element is inserted, and the slots 2203a and 2203b for insertion of the polarizers 206a and 206b as shown in FIG. 22 are formed with a width of 100 μm on both sides of the slot 2202. Then, the liquid crystal element 205 is positioned by active alignment checking a place for insertion, and thereafter, the liquid crystal element 205 is fixed by an ultraviolet-curing adhesive. Also, the polarizers 206a and 206b cut out so that the direction of transmitted polarized waves is horizontal are each fixed by an ultraviolet-curing adhesive. A waveguide having a smaller relative refractive-index difference A is used in order to reduce transmission loss due to the slots.

### Eighth Embodiment

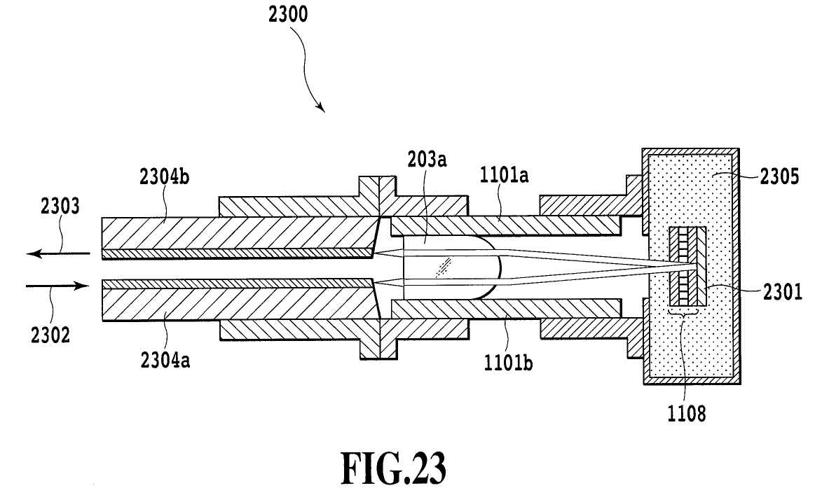

FIG. 23 shows a side view of a wavelength blocker 2300 according to an eighth embodiment, adopting a structure in which a reflection element 2301 is provided at the rear of the spatial modulation element 1108 of the wavelength blocker 1200 according to the second embodiment and is configured to reflect and return an optical signal. The wavelength blocker 2300 is characterized in that the cylindrical lens 203a serves as a lens for both incoming light 2302 traveling toward the spatial modulation element 1108 (the incoming light 2302 passes through a PLC 2304a including an AWG) and reflected outgoing light 2303 (the outgoing light 2303 passes through a PLC 2304b including an AWG), and thus, the required number of lenses is small. Also, the required number of aligning members is likewise small. As a result, the wavelength blocker 2300 has the advantageous effect of achieving a further reduction in the component count, thus reducing alignments at the time of packaging, and thus achieving further reductions in member cost, packaging time and packaging cost, as compared to the wavelength blocker 1200. Incidentally, in FIG. 23, the number of cylindrical lenses is one; however, it is to be understood that the number of lenses between the PLCs 2304a and 2304b and the spatial modulation element 1108 may be set to two, as in the case of the wavelength blocker 200. Also, in FIG. 23, an air gap is provided between the PLCs 2304a and 2304b; however, it is to be understood that the optical design of the lens or the like may be contrived to join the PLCs 2304a and 2304b together. Alternatively, in the wavelength blocker 2300, the PLCs 2304a and 2304b may be turned upside down so that the surfaces of the AWGs of the PLCs 2304a and 2304b are fixed to aligning jigs, or the surfaces of the PLCs 2304a and 2304b on which the AWGs are absent may be laminated together.

Incidentally, also in the wavelength blocker 2300, two liquid crystal elements 205 may be arranged in series in the spatial modulation element 1108 in order to increase the extinction ratio, as in the case of the wavelength blocker 200. The wavelength blocker 2300 is of a type in which light is reflected at the rear of the liquid crystal element 205, and the in-series arrangement of two liquid crystal elements 205 allows light to twice pass through the liquid crystal element sandwiched in between the polarizers, and thus enables increasing the extinction ratio.

Also, in the wavelength blocker 2300, light enters the glass surface or the polarizer in the liquid crystal element, with the optical axis being oblique, and thus, the reflection element 2301 on the back of the spatial modulation element 1108 becomes parallel to the spatial modulation element 1108 without having to be oblique, so that reflected light noise can be reduced to −40 dB or less, which in turn facilitates packaging.

Incidentally, here given is an instance where the spatial modulation element 1108 is sealed in a package 2305; however, it is to be understood that the structure may be such that the package 2305 is absent. On that occasion, if hermetic sealing is necessary, the overall module may be sealed in a package for hermetic sealing. The wavelength blocker 2300 has a small number of input and output optical fibers and thus facilitates sealing the overall module in the hermetic sealing package. Metal fibers may be used as the input and output optical fibers so that the fibers are soldered or otherwise sealed in points of contact with the package.

### Ninth Embodiment

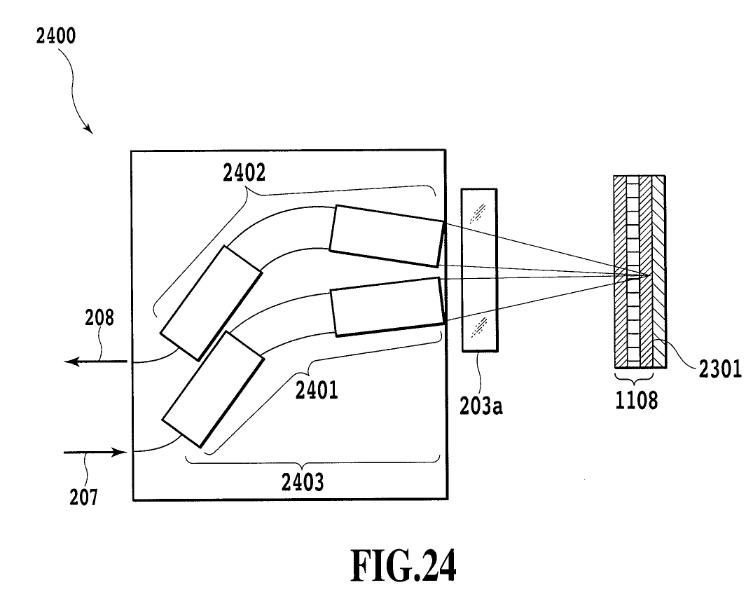

FIG. 24 shows a plan view of a wavelength blocker 2400 according to a ninth embodiment, having a structure in which the reflection element 2301 is provided immediately after the spatial modulation element 1108 so as to reflect light as in the case of the wavelength blocker 2300 according to the eighth embodiment, and further, an input AWG 2401, and an output AWG 2402 for outgoing light from the liquid crystal element are disposed in one PLC 2403.

Although the wavelength blocker 1200 is designed so that light enters the spatial modulation element 1108 perpendicularly thereto, the wavelength blocker 2400 is designed so that light from the AWG 2401 enters the spatial modulation element 1108 obliquely thereto and enters the output AWG 2402 as shown in FIG. 24.

Also, in the wavelength blocker 2400, light enters the glass surface or the polarizer in the liquid crystal element, with the optical axis being oblique, and thus, a mirror on the back of the liquid crystal element becomes parallel to the liquid crystal element without having to be oblique, so that the reflected light can be reduced to −40 dB or less.

Incidentally, the implementation structure may be in such a form as is shown in FIG. 13 or in such a form as is shown in FIG. 14.

The wavelength blocker 2400 is characterized in that two AWGs 2401 and 2402 are fabricated in one PLC 2403 and thus the area of the PLC per AWG is small, and also, the required number of cylindrical lenses 203a is one and thus the member cost can be reduced. Also, the component count of PLCs and lenses to be aligned during packaging is reduced, and thus, the packaging cost can be reduced.

### Tenth Embodiment

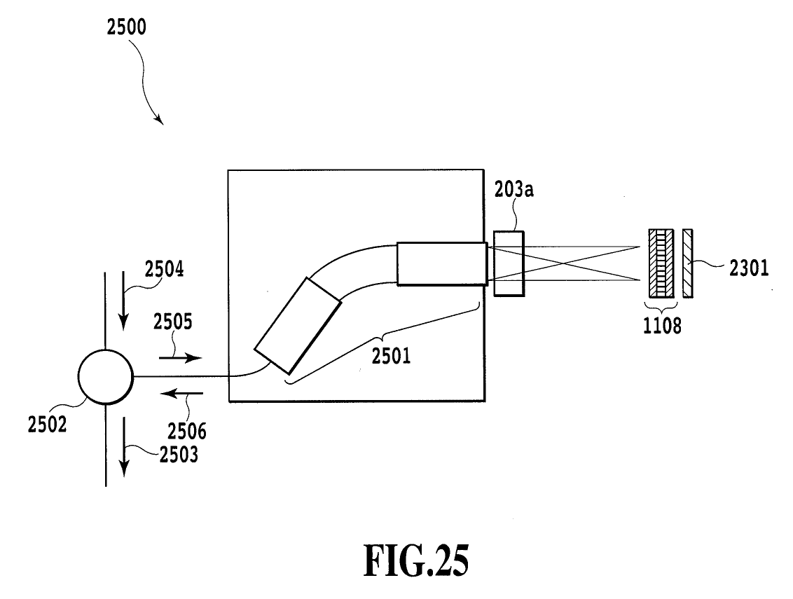

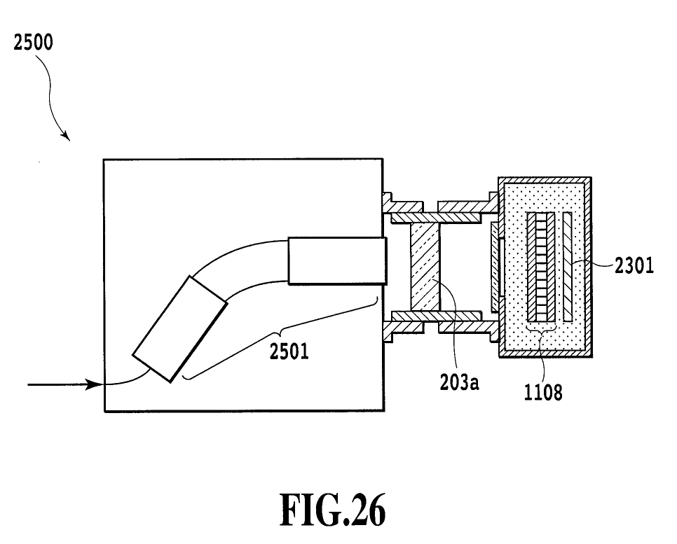

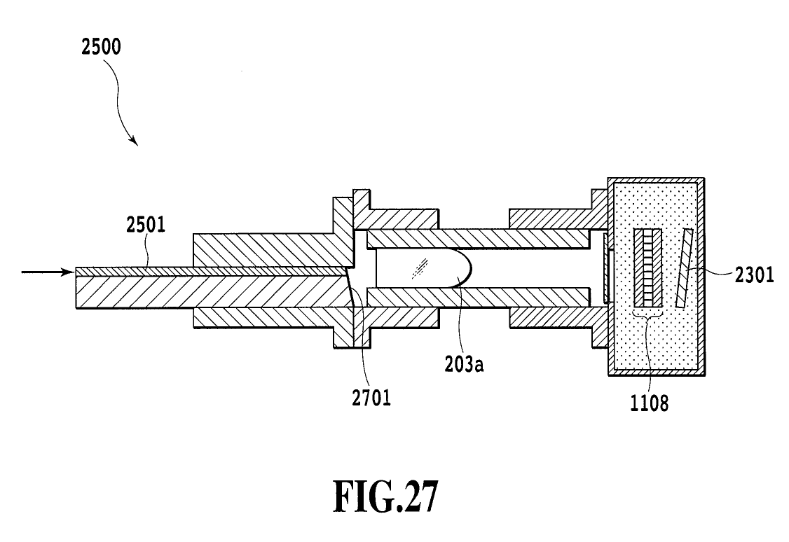

FIGS. 25 and 26 show plan views of a wavelength blocker 2500 according to a tenth embodiment, in which the one and same AWG 2501 is used as an input AWG and an output AWG. FIG. 27 shows a side view of the wavelength blocker 2500. In the wavelength blocker 2500, an output optical signal 2503 and an input optical signal 2504 are separated from each other for use, by a circulator 2502 installed at an entrance. Specifically, an optical signal 2505 enters the AWG 2501 and is spatially split into wavelengths by the spatial modulation element 1108. Then, optical signals corresponding to the wavelengths pass through the spatial modulation element 1108, are then reflected by the reflection element 2301, again pass through the spatial modulation element 1108, and are then multiplexed into an optical signal 2506 by the same AWG 2501. Here, in the optical path to the spatial modulation element 1108, the light intensity corresponding to each of the wavelength signals is adjusted or cut off. Then, the output optical signal 2506 traveling from right to left is separated from the input optical signal 2504 by the circulator 2502 in the output, thereby to form the output optical signal 2503, which then travels.

The wavelength blockers according to the first to ninth embodiments are called a transmission type, while the wavelength blocker according to the tenth embodiment is called a reflection type.

Incidentally, although light is reflected in the eighth and ninth embodiments, different AWGs are used as the input AWG and the output AWG, and thus, these embodiments are here classified as the transmission type.

The reflection type requires a means for suppressing reflected light noise, since reflected light from an optical surface before the mirror, e.g., the glass substrate for the liquid crystal element, a lens surface, or the like gets mixed in an optical signal to form noise. Incidentally, the wavelength blocker may possibly have to meet strict requirements that, during cutoff, the extinction ratio should be 40 dB or more, and a means for reflection reduction using an anti-reflection coating (typically having a return loss of −30 dB) may possibly be insufficient for reduction of reflection noise from the optical surface on the way.

Thus, the tenth embodiment uses an oblique end face to reduce reflected light. As shown in FIG. 27, an end face 2701 of the AWG 2501 that forms the PLC component is inclined for example 4 to 16 degrees. Also, the reflection element 2301 is inclined at an angle of the optical axis corresponding to the inclination of the end face (in FIG. 27, the inclination is shown as being larger than the actual inclination). By such inclination, all the reflecting surfaces on the way (specifically, the end face of the AWG 2501, the end face of the cylindrical lens 203a, the front and rear surfaces of the polarizer 206a included in the spatial modulation element 1108, and the front and rear surfaces of the glass substrates 602a and 602b of the liquid crystal element 205) are inclined relative to a direction perpendicular to the optical axis. Thus, the value of returned light reflected from these surfaces can be reduced for example to −40 dB or less for the intensity of the optical signal.

To fabricate the reflection type wavelength blocker module, it is required that the components be fixed in alignment to the optical aligning substrate as in the case of any one of the first, second and third embodiments, or alternatively that the components be directly connected in alignment with each other as shown in FIGS. 26 and 27, and the end faces are connected by the adhesive as in the case of the third embodiment. Any of these instances is substantially the same as the packaging of the transmission type wavelength blocker, and moreover, a lower component count leads to correspondingly easier packaging and also enables a reduction in manufacturing cost.

Comparison between the transmission type wavelength blocker according to the first embodiment and the reflection type wavelength blocker according to the tenth embodiment shows that the reflection type wavelength blocker has the advantage that the required numbers of AWGs and various lens components are typically each one and thus the manufacturing cost can be reduced. Further, the reflection type wavelength blocker has a small number of components to be aligned and thus enables a reduction in the packaging cost.

Incidentally, the collimating lenses are omitted from FIG. 25 for adaptation to the transmission type shown in FIG. 12; however, the collimating lenses may be added as shown in FIG. 2.

### Eleventh Embodiment

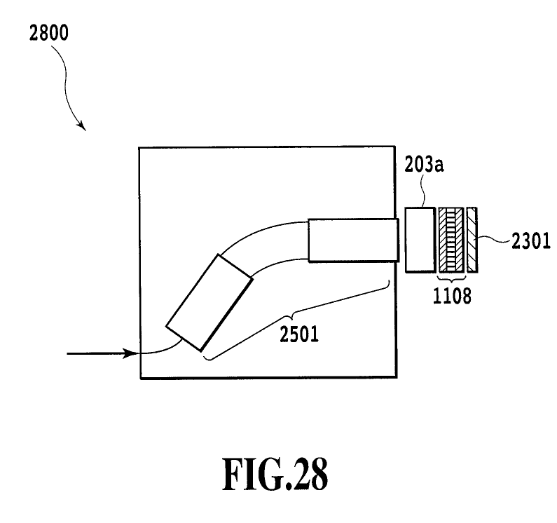

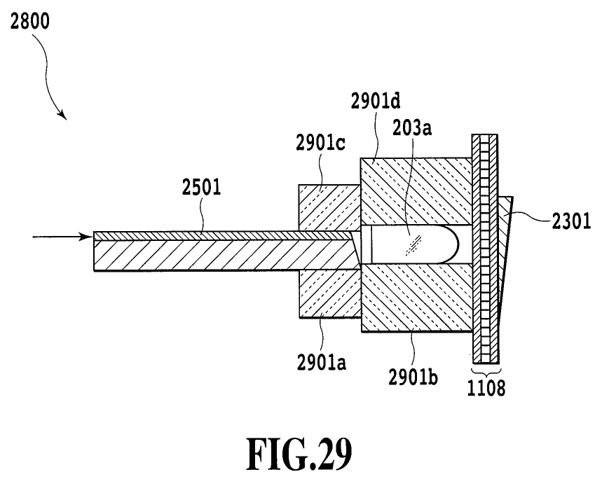

FIG. 28 shows a plan view of a wavelength blocker 2800 according to an eleventh embodiment, having optically the same structure as the wavelength blocker 2500 according to the tenth embodiment, and fabricated so that a glass block 2901 is adhesively fixed to the AWG 2501 and the spatial modulation element 1108. FIG. 29 shows a side view of the wavelength blocker 2800. If the reflection type wavelength blocker 2800 according to the eleventh embodiment is adapted for the transmission type, this corresponds to the wavelength blocker 1600 according to the third embodiment.

In the wavelength blocker 2800, YAG welding may be used to fix the members.

Also, the wavelength blocker 2800 may be configured in lens-less form in the following manner: the glass substrates 602a and 602b of the liquid crystal element 205 included in the spatial modulation element 1108 are thinned to reduce divergence of outgoing light from the AWG 2501, and also, the distance from the liquid crystal element 205 to the reflection element 2301 is shortened.

### Twelfth Embodiment

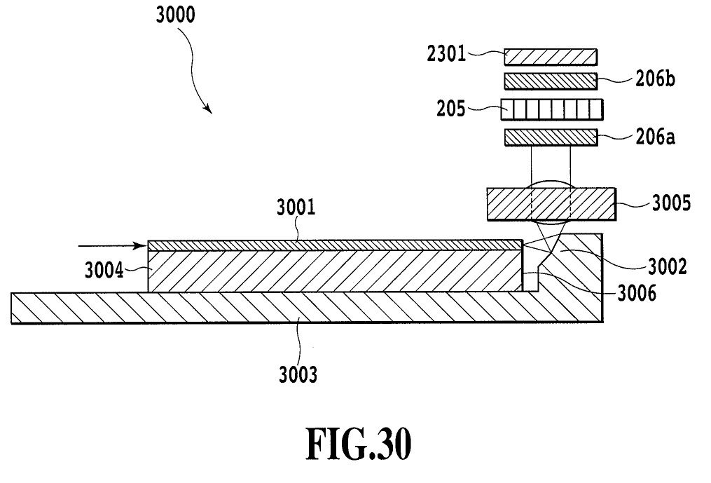

FIG. 30 shows a side view of a wavelength blocker 3000 according to a twelfth embodiment, in which a mirror surface 3002 configured so that the optical path extends perpendicularly upwardly toward the liquid crystal element 205 is interposed between an AWG 3001 and the liquid crystal element 205. In the wavelength blocker 3000, a PLC 3004 including the AWG 3001 is soldered and thereby fixed to a metal block 3003. Then, the metal block 3003 has the mirror surface 3002 formed thereon. Then, light exiting from the AWG 3001 and bouncing off on the mirror surface 3002 upwardly toward the liquid crystal element 205 travels through a lens 3005 and into the liquid crystal element 205 sandwiched in between the polarizers 206a and 206b. Then, the light is reflected by the reflection element 2301 above the polarizer 206b and bounces back to the original optical path. The advantage of such packaging is that the horizontal stacking of the lens 3005, the polarizers 206a and 206b, the liquid crystal element 205 and the reflection element 2301 increases the contact area and thus facilitates packaging. The components may be fixed in optimum coupling locations by YAG welding, soldering, an adhesive, or the like in combination with appropriate jigs.

Incidentally, for the wavelength blocker 3000, it is desirable that a PLC end face 3006 and the reflection element 2301 be inclined for example 4 to 12 degrees in order to prevent reflection, although not shown in FIG. 30.

Also, a concave mirror may be formed on the mirror surface 3002. Alternatively, the concave mirror coated and formed on glass may be fixed to metal to form an equivalent. When the concave mirror is used as the mirror, the lens 3005 may be omitted.

### Thirteenth embodiment

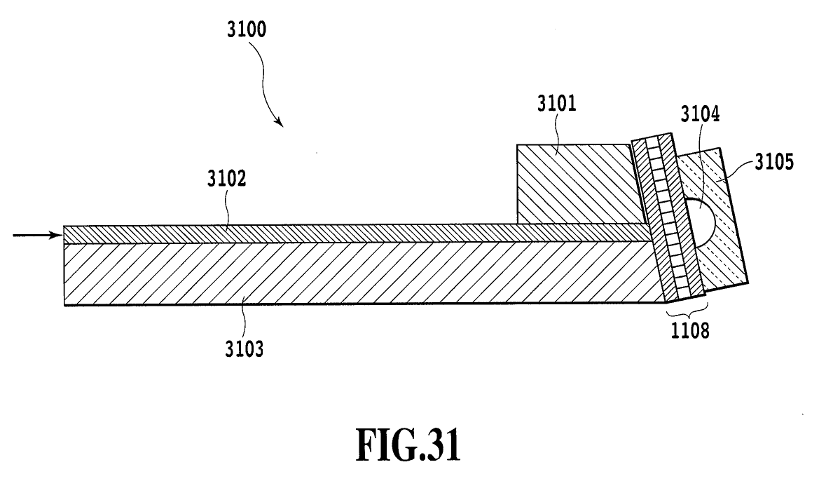

FIG. 31 shows a side view of a wavelength blocker 3100 according to a thirteenth embodiment having a concave mirror 3105. The wavelength blocker 3100 includes a PLC 3103 mounting an AWG 3102 having a contact area increased by a glass block 3101, the spatial modulation element 1108, and the concave mirror 3105. The PLC 3103 is given lamination of the glass block 3101 of 1 to 2 mm thick by an adhesive, and is then polished at an angle of about 8 degrees, in order to increase the contact area of the end face.

Light exiting from the AWG 3102 passes through the spatial modulation element 1108 and is reflected by a concave surface 3104 of the concave mirror 3105 rather than a plane mirror. The lens effect of the concave mirror 3105 enables omission of the lens before the spatial modulation element 1108. The omission of the lens leads to a correspondingly lower component count and thus facilitates packaging. It is to be noted that the concave mirror 3105 can bring vertically diverging light into convergence, as shown in FIG. 31. However, wavelength components of horizontally diverging light are not individually focused. It is therefore desirable that the spatial modulation element 1108 be thinned in order to individually bring the horizontally diverging light into convergence.

Incidentally, in FIG. 31, there is shown an instance where the lens before the spatial modulation element 1108 is omitted; however, it is to be understood that the lens may be interposed here.

### Fourteenth Embodiment

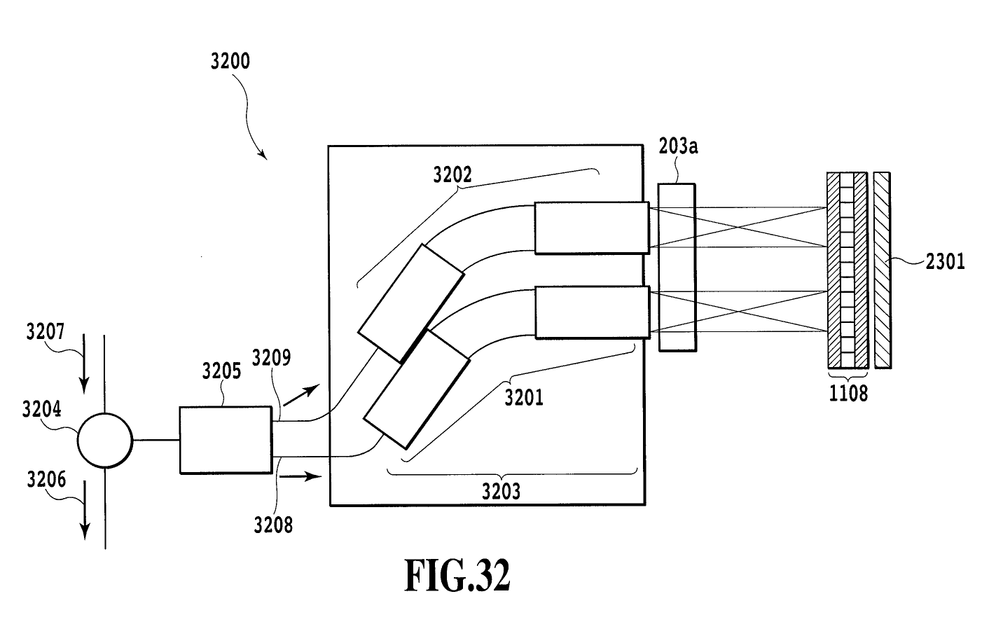

FIG. 32 shows a plan view of a wavelength blocker 3200 according to a fourteenth embodiment, designed to eliminate the polarization dependence. As described in detail below, all the reflection type wavelength blockers 2500, 2800, 3000 and 3100 according to the tenth to thirteenth embodiments may be designed for polarization independence in the same manner as the fourteenth embodiment. This corresponds to the transmission type wavelength blocker 2100.

Input and output optical fibers are connected to a circulator 3204, which is connected to a PBS 3205. The PBS 3205 is linked to a PLC 3203 by polarization holding fibers 3208 and 3209. Incoming light 3207 travels from the circulator 3204 to the PBS 3205. The PBS 3205 splits the incoming light 3207 by polarization, and, as shown for example in FIG. 32, the light travels through the optical fiber 3208 in the direction of polarization perpendicular to the sheet, while the light travels through the optical fiber 3209 in the direction of polarization parallel to the sheet. Here, the principal axis of the polarization holding optical fiber 3208 on the left side is rotated 90 degrees between the PBS 3205 and the AWG 3201, so that the light parallel to the sheet travels through the AWG 3201. As a result, the light entering the AWGs 3201 and 3202 is the light traveling in the same direction of polarization. This enables use of the module having the polarization dependence, without depending on polarization.

Incidentally, in FIG. 32, there is shown an instance where an optical fiber pigtail type PBS is used as an element for polarization splitting; however, a silica-base PLC, for example, may be used to form the PBS. In this case, a PBS circuit is fabricated on one and the same substrate in the input of the PLC 3203 shown in FIG. 32, or the PLC having the PBS fabricated therein and the PLC 3203 shown in FIG. 32 are connected by PLC-PLC connection. This enables downsizing.

Incidentally, the fourteenth embodiment gives an instance where the principal axis of the polarization holding optical fiber is rotated 90 degrees to rotate the direction of polarization; however, other means such as a half-wave plate may be used as a means for rotating the direction of polarization.

Incidentally, the fourteenth embodiment is given as a representative example of the wavelength blocker designed for polarization independence; however, the reflection type wavelength blockers according to the eleventh to thirteenth embodiments may be designed for polarization independence in the same manner as mentioned above.

### Fifteenth Embodiment

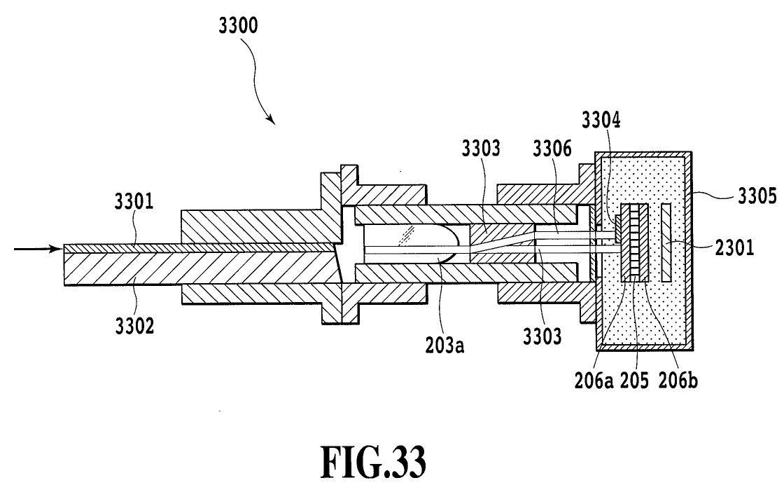

FIG. 33 shows a side view of a wavelength blocker 3300 according to a fifteenth embodiment, designed for polarization independence. As shown in FIG. 33, the wavelength blocker 3300 is the wavelength blocker of a type in which a polarization separator 3303 is interposed between the cylindrical lens 203a and the liquid crystal element 205.

Light exiting from an AWG 3301 passes through the cylindrical lens 203a and is spatially separated upwardly and downwardly in accordance with the direction of polarization by the polarization separator 3303. In this case, the light is trapped in a package of the polarization separator 3303, and the horizontally polarized light and the vertically polarized light are separated downwardly and upwardly, respectively, and enter into the liquid crystal element 205 sandwiched in between the polarizers 206a and 206b. Here, a half-wave plate 3304 is laminated on the surface of the polarizer 206a on the upper optical axis, with the principal axis oriented at an angle of 45 degrees, and thus, only horizontally polarized components of upper light 3306 enter the polarizer 206a, so that the polarization state of the upper light 3306 is identical to that of lower light 3307. Therefore, the wavelength blocker according to the fifteenth embodiment enables polarization-independent operation. In the wavelength blocker 3300, such optical fiber routing as is found in a wavelength blocker 3200 according to the fourteenth embodiment is short, and thus, the wavelength blocker can become more compact.

Incidentally, the wavelength blocker 3300 has a suitable packaging structure for YAG welding, as in the case of the wavelength blocker 1200 according to the second embodiment; however, other packaging structures, e.g., a suitable packaging structure for adhesive fixing for use in the wavelength blocker 2800 according to the eleventh embodiment, may be used for packaging.

### Sixteenth Embodiment

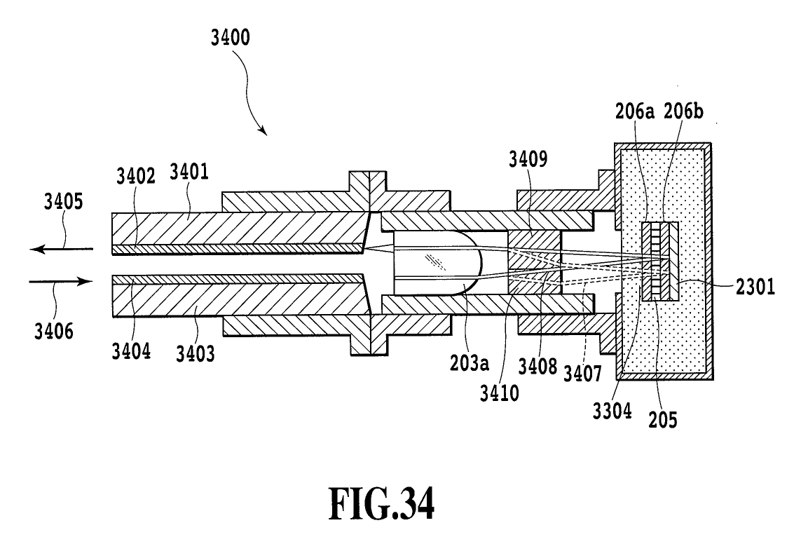

FIG. 34 shows a side view of a wavelength blocker 3400 according to a sixteenth embodiment, designed for polarization independence. The wavelength blocker 3400 is another wavelength blocker designed for polarization independence, and the wavelength blocker 3300 according to the fifteenth embodiment designed for polarization independence is implemented as the transmission type to form the wavelength blocker 3400.

An optical signal 3406 inputted to the wavelength blocker 3400 exits from an AWG 3404 of a PLC 3403, passes through the cylindrical lens 203a, and is spatially separated upwardly and downwardly in accordance with the direction of polarization of the light by a polarization separator 3410. In this case, the light is trapped in a package of the polarization separator, and the horizontally polarized light and the vertically polarized light are separated upwardly and downwardly, respectively, and enter the liquid crystal element 205 sandwiched in between the polarizers 206a and 206b. Here, the half-wave plate 3304 is laminated on the surface of the polarizer 206a on the lower optical axis, with the principal axis oriented at an angle of 45 degrees, and thus, only horizontally polarized components of lower light 3407 also enter the polarizer 206a, so that the polarization state of the lower light 3407 is identical to that of upper light 3408. Therefore, the wavelength blocker 3400 enables polarization-independent operation. Finally, the light reflected by the reflection element 2301 is multiplexed by a polarization separator 3409 and passes through an AWG 3402 of a PLC 3401 to form an optical signal 3405, which is then outputted.

The wavelength blocker 3400 is characterized by eliminating the need for the circulator 2003 and the PBS 2004 of the wavelength blocker 2000 according to the fifth embodiment.

In the wavelength blocker 3400, the polarization separators 3409 and 3410 are used in combination; however, these polarization separators may be replaced by one polarization separator. In the wavelength blocker, the orientation, form or polarization separation direction of the polarization separator, or the like is not particularly limited, provided only that the polarization separator has the function of separating polarized light and orienting the separated polarized light in the same direction of polarization at the time of entry of the light into the liquid crystal element 205 and thereby achieving polarization independence.

Incidentally, in FIG. 34, the wavelength blocker 3400 has a suitable packaging structure for YAG welding, as in the case of the transmission type wavelength blocker according to the second embodiment; however, other packaging structures, e.g., a suitable packaging structure for adhesive fixing for use in the wavelength blocker 2800 according to the eleventh embodiment, may be used for packaging. Also, in the wavelength blocker 3400, light enters the glass surface or the polarizer in the liquid crystal element, with the optical axis being oblique, and thus, the reflection element 2301 on the back of the liquid crystal element 205 becomes parallel to the liquid crystal element 205 without having to be oblique, so that the reflected light can be greatly reduced for example to −40 dB or less. This leads to the advantage of facilitating packaging.

### INDUSTRIAL APPLICABILITY

The wavelength blocker according to the present invention is applicable to an optical communication system.

1. A wavelength blocker including a plurality of optical components capable of individually adjusting the intensities of optical signals of given wavelengths contained in an input wavelength division multiplexed optical signal, the wavelength blocker comprising:
an input optical fiber through which the wavelength division multiplexed optical signal is inputted;
an input optical element that demultiplexes the optical signals contained in the wavelength division multiplexed optical signal;
an input wavefront control element that transmits the optical signals demultiplexed by the optical element;
a spatial modulation element that individually adjusts the intensities of optical signals of respective wavelengths passed through the input wavefront control element and demultiplexed in a space;
an output wavefront control element that transmits optical signals having passed through the spatial modulation element;
an output optical element that multiplexes the optical signals having passed through the wavefront control element; and
an output optical fiber through which the optical signal having passed through the output optical element is outputted.

2. The wavelength blocker according to claim 1, wherein light of any diffraction order other than diffraction order m, contained in the optical signal having passed through the input optical element, is cut off by a light shield portion of the spatial modulation element, and only an optical signal of the diffraction order m is inputted to the spatial modulation element (where m represents any given integer).

3. A wavelength blocker including a plurality of optical components capable of individually adjusting the intensities of optical signals of given wavelengths contained in an input wavelength division multiplexed optical signal, the wavelength blocker comprising:
an input optical fiber through which the wavelength division multiplexed optical signal is inputted;
an input waveguide optical circuit that demultiplexes the optical signals contained in the wavelength division multiplexed optical signal;
a spatial modulation element that individually adjusts the intensities of the optical signals of the respective wavelengths demultiplexed by the waveguide optical circuit;
an output waveguide optical circuit that multiplexes optical signals having passed through the spatial modulation element; and
an output optical fiber through which an optical signal having passed through the output waveguide optical circuit is outputted.

4. The wavelength blocker according to claim 3, further comprising a concave mirror configured to bend or return the optical signals having passed through the spatial modulation element, and if the wavelength blocker has the wavefront control element, a wavefront control element is commonly used as the input wavefront control element and the output wavefront control element.

5. The wavelength blocker according to claim 1, further comprising:
a polarization diversity unit including a circulator connected to the input optical fiber and the output optical fiber and a polarization beam splitter,
wherein the circulator is connected to the polarization beam splitter, and two outputs from the polarization beam splitter are connected to the input optical fiber and the output optical fiber, respectively, whereby the wavelength blocker is configured as a polarization-independent type, and
a polarization adjusting means for adjusting the polarization state of the optical signal passing through the optical fiber, and rotating 90 degrees only any one of a principal axis of an output polarization holding optical fiber and a principal axis of an input polarization holding optical fiber,
wherein the output from the polarization beam splitter is connected to the optical fiber by the polarization holding optical fiber, and the polarization adjusting means provides adjustment so that the polarization state of the optical signal passing through the input polarization holding optical fiber, polarized and split by the polarization beam splitter, is identical to that of the optical signal passing through the output polarization holding optical fiber.

6. (canceled)

7. A wavelength blocker including a plurality of optical components capable of individually adjusting the intensities of optical signals of given wavelengths contained in an input wavelength division multiplexed optical signal, the wavelength blocker comprising:
an input optical fiber through which the wavelength division multiplexed optical signal is inputted;
an optical element that demultiplexes the optical signals contained in the wavelength division multiplexed optical signal;
a wavefront control element that transmits the optical signals demultiplexed by the optical element;
a spatial modulation element that individually adjusts the intensities of the optical signals of the respective wavelengths having passed through the wavefront control element;
a reflection element that reflects and returns optical signals having passed through the spatial modulation element thereby to send the optical signals back to the spatial modulation element; and
an output optical fiber through which a wavelength division multiplexed optical signal is outputted, said wavelength division multiplexed optical signal is obtained by, in the optical element, multiplexing the optical signals having returned to the spatial modulation element and again passed through the wavefront control element.

8. A wavelength blocker including a plurality of optical components capable of individually adjusting the intensities of optical signals of given wavelengths contained in an input wavelength division multiplexed optical signal, the wavelength blocker comprising:
an input optical fiber through which the wavelength division multiplexed optical signal is inputted;
a waveguide optical circuit that demultiplexes the optical signals contained in the wavelength division multiplexed optical signal;
a spatial modulation element that individually adjusts the intensities of the optical signals of the respective wavelengths, the spatial modulation element having a light shield portion configured to modulate optical signals having passed through the waveguide optical circuit, and to cut off part of the optical signals;
a reflection element that reflects and returns the optical signal having passed through the spatial modulation element thereby to send the optical signals back to the spatial modulation element; and
an output optical fiber through which a wavelength division multiplexed optical signal is outputted, said wavelength division multiplexed optical signal is obtained by, in the optical element, multiplexing the optical signals having returned to the spatial modulation element and again passed through the waveguide optical circuit.

9. The wavelength blocker according to claim 8, wherein the reflection element is a concave mirror.

10. The wavelength blocker according to claim 8, further comprising:
a polarization diversity unit including a circulator connected to the input optical fiber and the output optical fiber and a polarization beam splitter,
wherein the circulator is connected to the polarization beam splitter, and two outputs from the polarization beam splitter are connected to the input optical fiber and the output optical fiber, respectively, whereby the wavelength blocker is configured as a polarization-independent type.

11. The wavelength blocker according to claim 10, further comprising:
a polarization adjusting means for adjusting the polarization state of the optical signal passing through the optical fiber, and rotating 90 degrees only any one of a principal axis of an output polarization holding optical fiber and a principal axis of an input polarization holding optical fiber,
wherein the output from the polarization beam splitter is connected to the optical fiber by the polarization holding optical fiber, and the polarization adjusting means provides adjustment so that the polarization state of the optical signal passing through the input polarization holding optical fiber, polarized and split by the polarization beam splitter, is identical to that of the optical signal passing through the output polarization holding optical fiber.

12. The wavelength blocker according to claim 10, wherein the spatial modulation element for each of the two wavelength blockers according to claim 10 is integrally fabricated.
